(19) United States
(12) Patent Application Publication
(10) Pub. No.: US 2026/0131673 A1
(43) Pub. Date: May 14, 2026

(54) VEHICLE

(71) Applicant: ISUZU MOTORS LIMITED, Yokohama-shi (JP)

(72) Inventors: Hiroshi YAMADA, Fujisawa-shi (JP); Hiromitsu WATANABE, Fujisawa-shi (JP)

(21) Appl. No.: 19/355,298

(22) Filed: Oct. 10, 2025

(30) Foreign Application Priority Data
Nov. 12, 2024 (JP) 2024-197562

(51) Int. Cl. B60L 50/60; B60L 53/80

(52) U.S. Cl. CPC B60L 50/66; B60L 53/80

(57) ABSTRACT

A vehicle includes a vehicle frame that extends in a front-rear direction, a first battery that is provided on a side surface of the vehicle frame in a vehicle width direction, and is replaceable, a support portion that is connected to the vehicle frame, and supports the first battery, and a plurality of side guards that are provided at predetermined intervals along the front-rear direction outward of the first battery in the vehicle width direction. The plurality of side guards include a first side guard supported on a support surface of the support portion parallel to the front-rear direction.

### CROSS-REFERENCE TO RELATED APPLICATIONS

The present application claims priority to Japanese Patent Applications number 2024-197562, filed on November 12, 2024 contents of which are incorporated herein by reference in their entirety.

### BACKGROUND OF THE INVENTION

The present disclosure relates to a vehicle having a side guard.

A vehicle such as a truck has a side guard for preventing a pedestrian, a bicycle, and the like from being caught. A side guard disclosed in Japanese Unexamined Patent Application Publication No. 2015-81532 is provided along a front-rear direction on an outer side of a vehicle frame.

In recent years, from the viewpoint of shortening a charging time and the like, a system has been proposed in which, when a remaining capacity of a battery provided in a vehicle frame is reduced, the battery is replaced with a charged battery. However, when the side guard is provided on the vehicle, the battery comes into contact with the side guard during replacement, and therefore the replacement operation cannot be carried out smoothly.

### BRIEF SUMMARY OF THE INVENTION

The present disclosure focuses on this point, and an object thereof is to easily replace a battery in a vehicle having a side guard.

An aspect of the present disclosure provides a vehicle that includes a vehicle frame that extends in a front-rear direction, a first battery that is provided on a side surface of the vehicle frame in a vehicle width direction, and is replaceable, a support portion that is connected to the vehicle frame, and supports the first battery, and a plurality of side guards that are provided at predetermined intervals along the front-rear direction outward of the first battery in the vehicle width direction, wherein the plurality of side guards include a first side guard supported on a support surface of the support portion parallel to the front-rear direction.

### BRIEF DESCRIPTION OF THE DRAWINGS

FIG. 1 schematically shows a peripheral configuration of a side guard 40L in a left region of a vehicle 1.

FIG. 2 shows a state in which a first battery 20L is moved.

FIG. 3 shows a support structure of a first side guard 42L on a support portion 30L.

FIG. 4 schematically shows a side guard 140 according to a comparative example.

FIG. 5 schematically shows a peripheral configuration of a side guard 40R on a right region of the vehicle 1.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Vehicle configuration

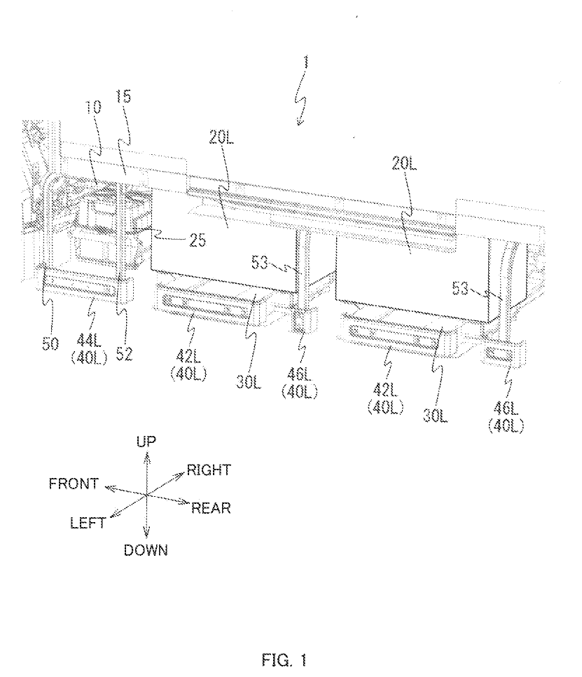

FIG. 1 schematically shows a peripheral configuration of a side guard 40L in a left region of a vehicle 1. The vehicle 1 has a frame structure, and is a truck as an example here. The vehicle 1 is a Battery Electric Vehicle (BEV) to which electric power is supplied from a battery to a drive motor, for example.

The vehicle 1 has a side guard for preventing a pedestrian, a bicycle, or the like from being caught, and the side guard of the present embodiment is divided. As shown in FIG. 1, the vehicle 1 includes a vehicle frame 10, a mounted body 15, first batteries 20L, a second battery 25, support portions 30L, and the side guard 40L.

The vehicle frame 10 extends in a front-rear direction of the vehicle 1. Specifically, the vehicle frame 10 is a pair of side frames extending in the front-rear direction of the vehicle 1. The pair of side frames are connected to a cross member extending in a vehicle width direction. For example, a drive motor, a cab, and the like are supported on the vehicle frame 10.

The mounted body 15 is supported by the vehicle frame 10. The mounted body 15 is located behind the cab on the vehicle frame 10. The mounted body 15 is a cargo bed, for example, and is supported on an upper surface of the vehicle frame 10.

The first batteries 20L are provided on a side surface of the vehicle frame 10 in the vehicle width direction. The first batteries 20L are lithium ion batteries, for example. The first batteries 20L supply electric power to the drive motor, for example. Here, two first batteries 20L are provided at a predetermined interval in the front-rear direction. However, the present disclosure is not limited thereto, and a single first battery 20L may be employed.

The first batteries 20L are replaceable batteries. For example, when remaining capacities of the first batteries 20L are reduced, the first batteries 20L are replaced with new first batteries 20L (for example, charged first batteries 20L) at a replacement station. Specifically, a replacement arm installed in the replacement station mounts the new first batteries 20L after removing the first batteries 20L mounted on the vehicle 1.

A second battery 25 is supported by the vehicle frame 10. The second battery 25 is a lead battery, for example, and supplies electric power to an auxiliary device of the vehicle 1. Unlike the first batteries 20L, the second battery 25 is not replaced at the replacement station.

The support portions 30L support the first batteries 20L. Two support portions 30L are provided, like the first batteries 20L, and the two support portions 30L have the same configuration.

The support portions 30L are located below the first batteries 20L and are coupled to the vehicle frame 10. The support portions 30L have a flat-plate shape, and support bottom surfaces of the first batteries 20L. The support portions 30L are movable in the vehicle width direction. Specifically, the support portions 30L are movable along rails provided parallel to the vehicle width direction while supporting the first batteries 20L. The rails are provided on both sides of the support portions 30L, and the support portions 30L slide along the rails. In other words, the rails guide the support portions 30L, which support the first batteries 20L, so as to be movable in the vehicle width direction.

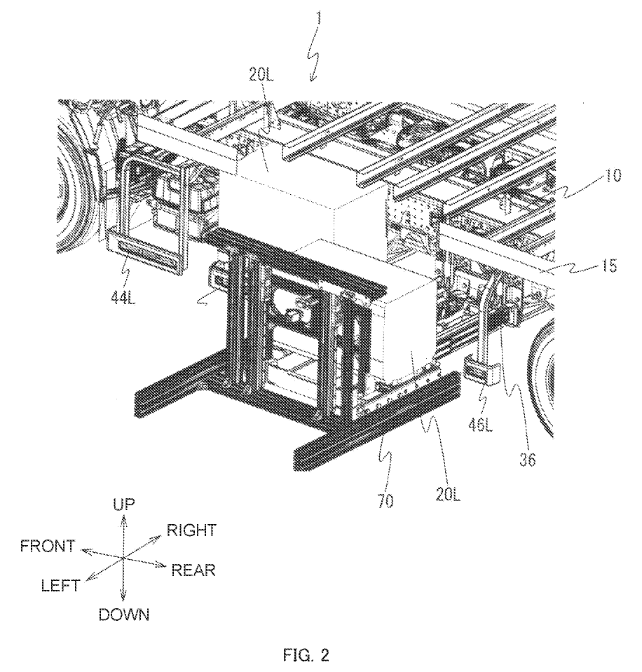

FIG. 2 shows a state in which the first battery 20L is moved. The support portion 30L becomes positioned at a replacement position for the first battery 20L shown in FIG. 2 by moving outward in the vehicle width direction along the rails 36. Here, the support portion 30L is moved to the replacement position by an arm 70 installed at the replacement station. When the support portion 30L is positioned at the replacement position, the first battery 20L is replaced.

The side guard 40L prevents a pedestrian, a bicycle, or the like from being caught. For example, the side guard 40L is provided between front wheels and rear wheels of the vehicle 1, and prevents a pedestrian or the like from being caught by the rear wheels. A plurality of side guards 40L are provided at predetermined intervals along the front-rear direction outward of the first batteries 20L and the second battery 25 in the vehicle width direction. The plurality of side guards 40L are provided at the same position in the vehicle height direction.

As shown in FIG. 1, the plurality of side guards 40L include first side guards 42L, a second side guard 44L, and third side guards 46L. The first side guards 42L, the second side guard 44L, and the third side guards 46L are provided in a divided manner.

The first side guards 42L are provided at positions corresponding to the first batteries 20L in the front-rear direction. Specifically, the first side guards 42L are provided at positions facing the support portions 30L that support the first batteries 20L. Since there are two first batteries 20L, two first side guards 42L are also provided. The two first side guards 42L have the same configuration.

The first side guards 42L are supported by the support portions 30L. Specifically, the first side guards 42L are supported by support surfaces of the support portions 30L parallel to the front-rear direction. Therefore, the first side guards 42L move together with the support portions 30L when the support portions 30L move. The first side guards 42L are positioned below the first batteries 20L in the vehicle height direction. Accordingly, when the first batteries 20L are replaced, the first batteries 20L do not interfere with the first side guards 42L, so that an operator can smoothly replace the first batteries 20L.

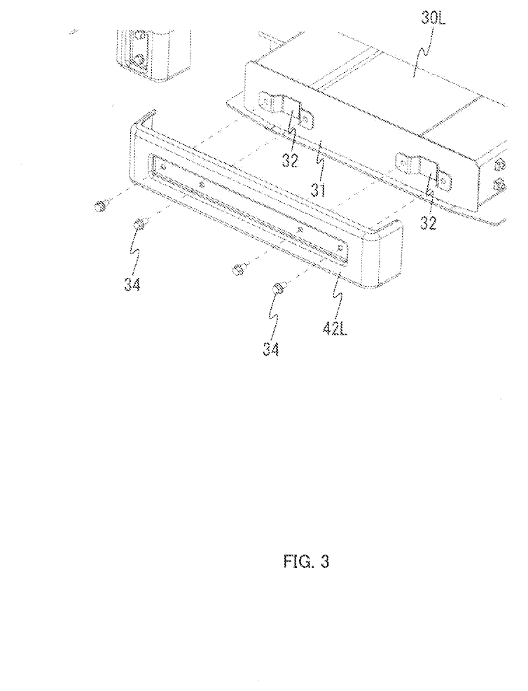

FIG. 3 shows a support structure of the first side guard 42L on the support portion 30L. A plurality of (e.g., two) fixing brackets 32 are provided on a support surface 31 of the support portion 30L. The support surface 31 is a surface on the outer side in the vehicle width direction among surfaces parallel to the front-rear direction of the support portion 30L. The plurality of fixing brackets 32 are fixed to the support surface 31 of the support portion 30L. The first side guard 42L is fixed to the plurality of fixing brackets 32. Specifically, the first side guard 42L is fixed to the fixing brackets 32 by screwing fastening members (for example, screws) 34 into screw holes of the fixing brackets 32. The fixing brackets 32 have a so-called hat shape in order to secure a space in which the fastening members 34 are screwed into the screw holes, but are not limited thereto.

Returning to FIG. 1, lengths of the first side guards 42L in the front-rear direction are smaller than lengths of the first batteries 20L in the front-rear direction. Specifically, the lengths of the first side guards 42L in the front-rear direction are equal to lengths of the support portions 30L in the front-rear direction. Accordingly, when the arm 70 (FIG. 2) moves the support portion 30L to the replacement position, the arm 70 can be prevented from coming into contact with the first side guard 42L.

The second side guard 44L is provided at a position corresponding to the second battery 25 in the front-rear direction. The second side guard 44L is located below the second battery 25 in the vehicle height direction. Height of the second side guard 44L in the vehicle height direction is the same as height of the first side guards 42L in the vehicle height direction. As a result, when the operator removes a case above the second battery 25 to perform work such as inspection, the second side guard 44L is located at a position that does not interfere with the work, and thus the operator can smoothly perform the work.

The second side guard 44L is supported by a first stay 50 and a second stay 52 extending from the mounted body 15. The first stay 50 supports one end portion of the second side guard 44L. The second stay 52 supports the other end portion of the second side guard 44L. Since both end portions of the second side guard 44L are supported by the first stay 50 and the second stay 52 in this manner, the second side guard 44L is stably supported even when spaced apart from the mounted body 15.

The first stay 50 is oriented along the vehicle height direction in front of the second battery 25 in the front-rear direction. The second stay 52 is oriented along the vehicle height direction behind the second battery 25 in the front-rear direction. Accordingly, since the first stay 50 and the second stay 52 are located at positions away from the second battery 25 in the front-rear direction, it is easy for the operator to perform inspection work or the like of the second battery 25.

In the above description, the second side guard 44L is supported by the first stay 50 and the second stay 52, but is not limited thereto. For example, the second side guard 44L may be supported by a single stay extending from the mounted body 15.

The third side guard 46L is provided at a location in the front-rear direction of the vehicle 1 where the first side guard 42L and the second side guard 44L are not provided. Here, the third side guards 46L are provided i) between the two first side guards 42L and ii) between the first side guard 42L and the rear wheel. This disposes a plurality of divided side guards in a wide range in the front-rear direction, thereby preventing a pedestrian or the like from being caught. The third side guard 46L is supported by a stay 53 extending from the mounted body 15.

In the present embodiment, since the side guard 40L is divided into a plurality of sections, when moving the support portion 30L that supports the first battery 20L, the first battery 20L and the support portion 30L do not come into contact with the first side guard 42L, and so the first battery 20L can be easily replaced.

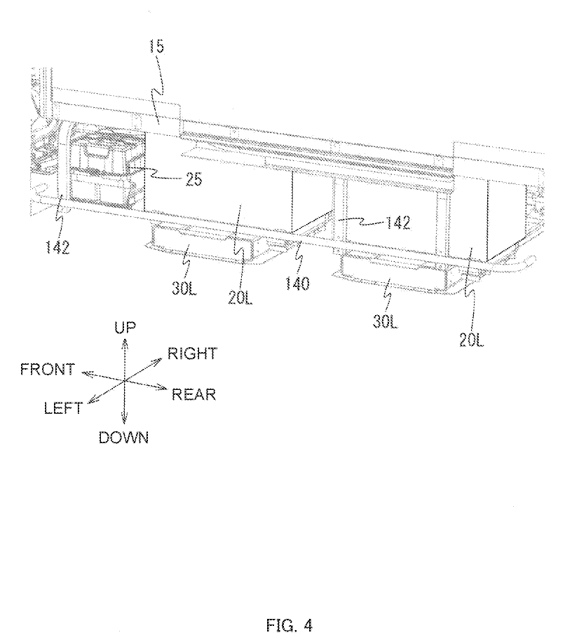

FIG. 4 schematically shows a side guard 140 according to a comparative example. The side guard 140 of the comparative example is not divided and is a single bar extending in the front-rear direction. In this case, when moving the support portion 30L that supports the first battery 20L, the first battery 20L contacts the side guard 140 and so the support portion 30L cannot be moved to the replacement position. In order to move the support portion 30L to the replacement position, it is necessary to remove the side guard 140.

In contrast, in the present embodiment, since the side guard 40L is divided and the first side guards 42L at the positions corresponding to the first batteries 20L are supported by the support portions 30L, the first batteries 20L do not come into contact with the first side guards 42L when moving the support portions 30L to the replacement positions.

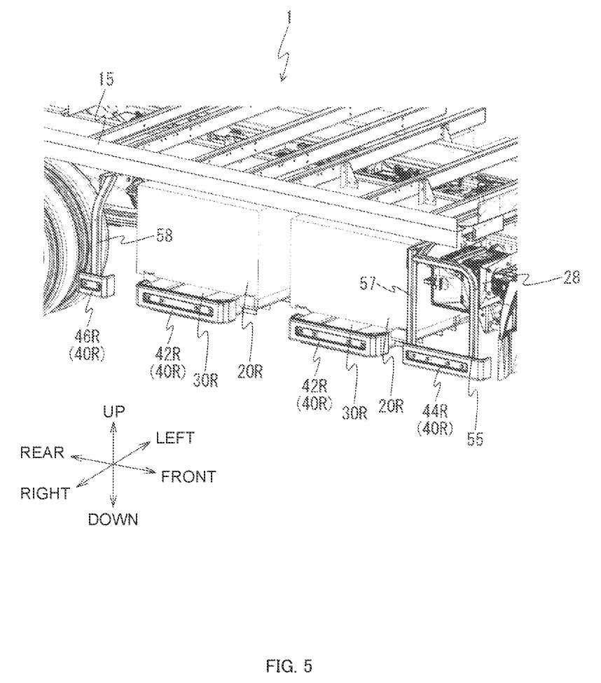

The configuration on the left of the vehicle frame 10 has been described above, and the configuration on the right of the vehicle frame 10 is the same. FIG. 5 schematically shows a peripheral configuration of a side guard 40R on a right region of the vehicle 1. First batteries 20R, a charging box 28, support portions 30R, and the side guard 40R are provided in the right of the vehicle frame 10.

The configurations of the first batteries 20R and the support portions 30R are the same as the configurations of the first batteries 20L and the support portions 30L shown in FIG. 1. Therefore, the support portions 30R are also movable in the vehicle width direction as shown in FIG. 2 in order to replace the first batteries 20R.

The charging box 28 is a box for charging the first battery 20R, for example. The charging box 28 is supported by the vehicle frame 10. The charging box 28 is provided on the opposite side of the second battery 25 as viewed from the vehicle frame 10. When a charging gun is attached to the charging box 28, the first battery 20R is charged.

Like the side guard 40L in the left region of the vehicle frame 10, the side guard 40R is divided into a first side guard 42R, a second side guard 44R, and a third side guard 46R. Therefore, the first battery 20R can be smoothly replaced on the right of the vehicle frame 10. In particular, since the first side guard 42R is supported by the support portion 30R, it is possible to prevent the first side guard 42R from becoming an obstacle when the support portion 30R is moved by the arm 70 (FIG. 2) for replacement of the first battery 20R.

The second side guard 44R is provided at a position corresponding to the charging box 28 in the front-rear direction. The second side guard 44R is located below the charging box 28 in the vehicle height direction. As a result, when the operator opens and closes a door of the charging box 28, the door does not come into contact with the second side guard 44L, thereby smoothly performing the charging operation.

The second side guard 44R is supported by a first stay 55 and a second stay 57 extending from the mounted body 15. The first stay 55 supports one end portion of the second side guard 44R. The second stay 57 supports the other end portion of the second side guard 44R. Since both end portions of the second side guard 44R are supported by the first stay 55 and the second stay 57 in this manner, the second side guard 44R is stably supported even when spaced apart from the mounted body 15.

The first stay 55 is oriented along the vehicle height direction in front of the charging box 28 in the front-rear direction. The second stay 57 is oriented along the vehicle height direction behind the charging box 28 in the front-rear direction. It should be noted that the first stay 55 is formed in an L-shape, and a portion thereof extending in the front-rear direction is connected to the second stay 57. The portion is located above the charging box 28 in the vehicle height direction. Accordingly, since the first stay 55 and the second stay 57 are located at positions away from the charging box 28, the operator can easily perform the charging operation.

The third side guard 46R is provided at a location in the front-rear direction of the vehicle 1 where the first side guards 42R and the second side guard 44R are not provided. The third side guard 46R is supported by a stay 58 extending from the mounted body 15.

### Effects of embodiment

The vehicle 1 of the above-described embodiment includes i) the replaceable first batteries 20L provided on the side surface of the vehicle frame 10 in the vehicle width direction, ii) the support portions 30L that support the first batteries 20L, and iii) the plurality of side guards 40L provided at predetermined intervals along the front-rear direction outward of the first batteries 20L in the vehicle width direction. The plurality of side guards 40L include the first side guards 42L supported on the support surfaces 31 of the support portions 30L parallel to the front-rear direction.

Accordingly, of the side guards obtained by dividing the side guard, by having the first side guard 42L is supported by the support portion 30L, the first battery 20L does not come into contact with the first side guard 42L when replacing the first battery 20L. Therefore, the operator can smoothly replace the first battery 20L with the first side guard 42L being supported by the support portion 30L.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A vehicle comprising:
a vehicle frame that extends in a front-rear direction;
a first battery that is provided on a side surface of the vehicle frame in a vehicle width direction, and is replaceable;
a support portion that is connected to the vehicle frame, and supports the first battery; and
a plurality of side guards that are provided at predetermined intervals along the front-rear direction outward of the first battery in the vehicle width direction, wherein
the plurality of side guards include a first side guard supported on a support surface of the support portion parallel to the front-rear direction.

2. The vehicle according to claim 1, wherein
a length of the first side guard in the front-rear direction is smaller than a length of the first battery in the front-rear direction.

3. The vehicle according to claim 1, wherein
the first side guard is located below the first battery in a vehicle height direction.

4. The vehicle according to claim 1, further comprising:
rails that are provided parallel to the vehicle width direction, and guide the support portion, which supports the first battery, so as to be movable in the vehicle width direction.

5. The vehicle according to claim 1, further comprising:
a plurality of fixing brackets that are fixed to the support surface of the support portion, wherein
the first side guard is fixed to the plurality of fixing brackets.

6. The vehicle according to claim 1, wherein
the plurality of side guards are provided at the same position in a vehicle height direction.

7. The vehicle according to claim 1, further comprising:
a mounted body that is supported by the vehicle frame, wherein
the plurality of side guards include second side guards supported by stays extending from the mounted body.

8. The vehicle according to claim 7, further comprising:
a second battery that is supported by the vehicle frame, wherein
the second side guard is provided at a position corresponding to the second battery in the front-rear direction,
the vehicle further comprising:
a first stay that is oriented along the vehicle height direction in front of the second battery in the front-rear direction, and supports one end portion of the second side guard; and
a second stay that is oriented along the vehicle height direction behind the second battery in the front-rear direction, and supports the other end portion of the second side guard.

9. The vehicle according to claim 7, further comprising:
a charging box that is supported by the vehicle frame, wherein
the second side guard is provided at a position corresponding to the charging box in the front-rear direction,
the vehicle further comprising:
a first stay that is oriented along the vehicle height direction in front of the charging box in the front-rear direction, and supports one end portion of the second side guard; and
a second stay that is oriented along the vehicle height direction behind the charging box in the front-rear direction, and supports the other end portion of the second side guard.
